(19) United States
(12) Patent Application Publication
(10) Pub. No.: US 2024/0169122 A1
(43) Pub. Date: May 23, 2024

(54) SYSTEMS AND METHODS FOR OPTIMIZED VEHICULAR SIMULATIONS

(71) Applicant: Foretellix Ltd., Ramat Gan (IL)

(72) Inventor: Ido AVRAHAM, Netanya (IL)

(73) Assignee: Foretellix Ltd., Ramat Gan (IL)

(21) Appl. No.: 18/510,113

(22) Filed: Nov. 15, 2023

Related U.S. Application Data
(60) Provisional application No. 63/384,546, filed on Nov. 21, 2022.

(51) Int. Cl. G06F 30/20

(52) U.S. Cl. CPC G06F 30/20; G06F 2111/10

(57) ABSTRACT

A method for providing a test scenario simulation of an interaction of a plurality of vehicles by a computer system comprises receiving a scenario involving at least the plurality of vehicles, wherein the scenario is described in a high-level scenario description language; receiving a plurality of parameter values for the received scenario; modifying the plurality of parameter values according to at least one of a pass/fail predictor model and a pass/fail indication; narrowing a range of values of at least one parameter of the plurality of parameters by prediction of at least a key performance indicator (KPI) value using a KPI predictor; and generating a test scenario for the simulation of the interaction of the plurality of vehicles within the received scenario based on at least the narrowed range of values.

### CROSS REFERENCE TO RELATED APPLICATIONS

This application claims the benefit of U.S. Provisional Application No. 63/384,546 filed on Nov. 21, 2022, the contents of which are hereby incorporated by reference.

### TECHNICAL FIELD

The present disclosure generally relates to systems and methods for simulations of vehicle motion and more specifically optimization of such simulations.

### BACKGROUND

Advances in the field of autonomous vehicles are rapid. More and more, such vehicles are scheduled to hit the roads in the coming decade, and experimental vehicles are roaming the roads of many cities around the world. Like every sophisticated device that has been designed by humans, the autonomous vehicle enjoys the benefit of the ingenuity of mankind, as well as experiencing its shortcomings. The latter manifest themselves as undesired, unpredicted, or erroneous behavior of the autonomous vehicle, putting in danger the vehicle's occupants as well as other people, animals, and property around the vehicle.

In order to prevent such errors from occurring, vehicles are first tested prior to their release to the roads, and the vehicles also have various precautions installed to ensure that no mishaps occur as they are deployed on the road. In addition, a driver is assigned to each such vehicle with a capability of overriding the operation of the vehicle when a handling or response error occurs. A facility is provided that captures information regarding such errors which enables the updating of the control systems of the vehicle so as to prevent future cases of such hazardous situations from occurring. However, these solutions are error-prone, as they are heavily dependent on the capture of such errors as a result of an intervention by the operator, or when some sort of damage has occurred. Thus, disadvantageously, errors that lead to an undesirable result are not monitored efficiently or captured.

It has been recognized that scenario-based testing can be used to monitor operations of autonomous vehicles based on predetermined expectations of proper operations. More particularly, scenario-based testing tests and verifies the practically endless number of scenarios that an autonomous vehicle may encounter on the road so as to develop a thoroughly tested drive-control system of autonomous vehicles. Creating a sufficiently large volume of scenario-based tests that are realistic and demanding is a major challenge, as evidenced by many accidents or close-calls of actual vehicles that were rigorously tested but whose testing was clearly insufficient or incomplete. High-level scenario descriptions that are parameterized are introduced as a way of generating such tests, however, selection of parameter values remains difficult, as the generated tests are often invalid or ineffective scenarios.

It would therefore be advantageous to provide a solution that improves the probability of the generation of valid and effective test scenarios.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for providing a test scenario simulation of an interaction of a plurality of vehicles by a computer system. The method comprises receiving a scenario involving at least the plurality of vehicles, wherein the scenario is described in a high-level scenario description language; receiving a plurality of parameter values for the received scenario; modifying the plurality of parameter values according to at least one of a pass/fail predictor model and a pass/fail indication; narrowing a range of values of at least one parameter of the plurality of parameters by prediction of at least a key performance indicator (KPI) value using a KPI predictor; and generating a test scenario for the simulation of the interaction of the plurality of vehicles within the received scenario based on at least the narrowed range of values.

Certain embodiments disclosed herein include a system for generation of a test scenario for simulation of a plurality of vehicles. The system comprises a processing circuitry; an input/output (IO) interface, communicatively connected to the processing circuitry and configured to provide communication to and from the system; a memory communicatively connected to the processing circuitry, a portion of the memory containing there in instructions that when executed by the processing circuitry configure the system to: receive a scenario involving at least the plurality of vehicles, wherein the scenario is described in a high-level scenario description language; receive a plurality of parameter values for the received scenario; modify the plurality of parameter values according to at least one of a pass/fail predictor model and a pass/fail indication; narrow a range of values of at least one parameter of the plurality of parameters by prediction of at least a key performance indicator (KPI) value using a KPI predictor; and generate a test scenario for the simulation of the interaction of the plurality of vehicles based on at least the narrowed range of values.

### BRIEF DESCRIPTION OF THE DRAWINGS

In the drawing:

FIG. 1 is a flowchart for determination of the parameter value range according to an embodiment;

FIG. 2 is a flowchart for narrowing of the parameter value range according to an embodiment;

FIG. 3 is a schematic block diagram of operation for optimization of vehicular simulations according to an embodiment; and

FIG. 4 is a schematic block diagram of a system having a memory with instructions that perform optimization of vehicular simulations according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include techniques for providing a plurality of concrete instances of objects for the execution of a simulation on a computer based on a scenario described in a high-level scenario description language for execution. Such a scenario is applicable, for example, to an autonomous vehicle within traffic. Accordingly, the concrete instance has to satisfy: 1) all constraints defined in the scenario; 2) all modifiers of the scenario; and 3) all operators defining the timing relationships between scenarios. According to an embodiment this is performed by representing the scenarios as a constraint satisfaction problem. Illustrative examples of autonomous vehicles include cars, trucks, motorcycles, locomotives, bicycles, scooters, drones, and the like, including any combinations thereof.

Tests for verification of autonomous systems in simulation are generated from high-level scenario descriptions by selecting parameter values for all parameters of the high-level scenario description. The selection process must result in tests that are valid, non-trivial, and demanding. Valid tests are those that do not violate physical and environmental constraints. Demanding tests are tests that explore corner conditions that are difficult to handle and that are not trivial variations of previously generated tests. Corner conditions represent extreme conditions within which a system is expected to still operate when within the boundaries of the corner conditions. The selection of parameters is done using an iterative process where the effect of past parameter values is used to construct a predictor for the selection of new parameter sets. In an embodiment, the predictor filters parameter selection in a way that optimizes the efficiency of the test generation process, which reduces the time necessary in order to generate the tests thereby reducing the use of computer resources by avoiding generation of useless tests which would otherwise result and therefore improving computer operations.

Optimization of parameter value selection for test creation is performed in two loops. In an embodiment, the two loops may be executed concurrently. The first loop a) receives parameter value ranges and high-level scenario descriptions; b) parameter values based on ranges are selected, test scenarios are created, where all parameters have values; c) a simulation is run for each of the created test scenarios; d) results of each simulation, along with its result pass/fail indication, are provided to the second loop; e) the results of each simulation are used to update a pass/fail predictor model; and f) the parameter value ranges are changed and used to produce new parameter value ranges which are likely to result in a passing test. High-level scenario descriptions may be defined in a scenario description language. The second loop has a key performance indicator (KPI) results predictor that predicts KPI values based on the input parameters. The KPI predictor is updated using input parameter values and their resulting KPI values; narrower ranges are selected for at least some of the parameters which are more likely to drive KPIs to desired values; the narrowed ranges are returned for processing by the first loop.

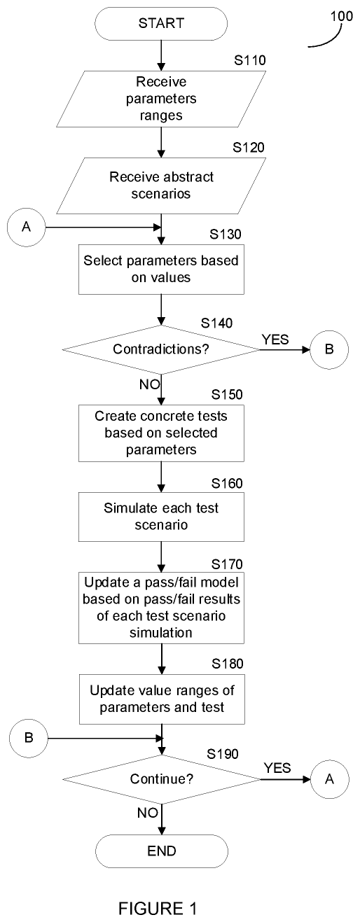

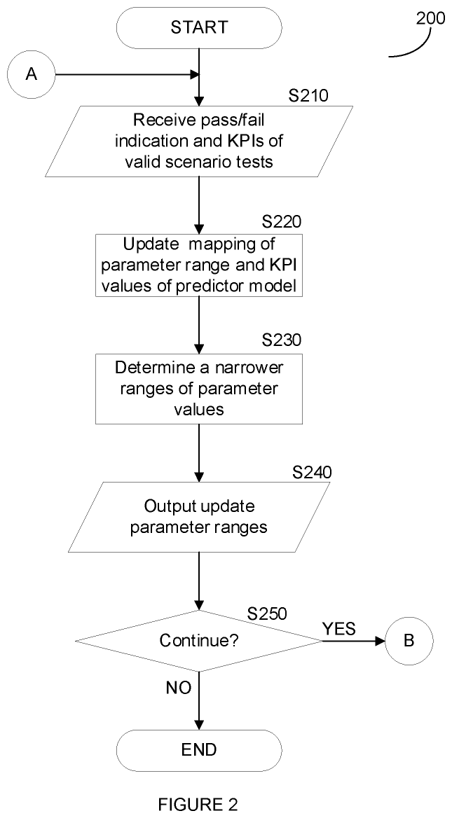

FIG. 1 is an example flowchart 100 for determining the parameter value range according to an embodiment. The process described by flowchart 100 may interact with or be executed in parallel with the flowchart 200 of FIG. 2 which is described in greater detail hereinbelow. The parameters provided are in the context of an optimization for a vehicular simulation and as further discussed hereinbelow.

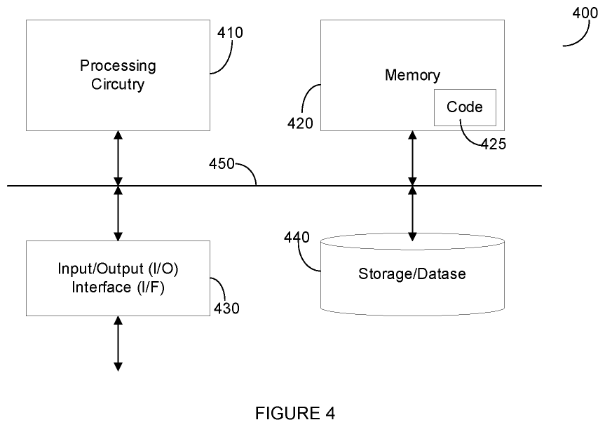

At S110 parameters and their respective ranges are received. Parameters could be, for example, speed, acceleration, deceleration, steering angle, intervehicle distance, etc. and may be received from storage, e.g., storage 440 of FIG. 4, a memory, e.g., memory 420 of FIG. 4, or collected in real-time via an input/output interface, e.g., Input/output interface 430 of FIG. 4. Illustrative ranges for such parameters are, for speed of a vehicle, 0-100 miles per hour (MPH); for speed of a human on foot, 0-10 MPH; for acceleration of a vehicle, 0-12 m/s²⁻; for deceleration of a vehicle, 0-25 m/s²⁻; for vehicle steering angle, 0-50°, and for distance between vehicles, 0 to infinity. The ranges may further include a statistical distribution for the values within the range, for example, a uniform distribution, a Gaussian distribution, a Poisson distribution, and other such distributions known to those of ordinary skill in the art. The received data may be updated by a process such as is shown generally in FIG. 2.

At S120 parametrized test files of the high-level scenario descriptions are received.

At S130 parameter values are selected to be employed with the received parameterized test files based on the ranges for each parameter. For example, a first vehicle may have a speed of 25 MPH while another vehicle may have a speed of 42 MPH. The first vehicle may be accelerating at 0 m/s², while the second vehicle may be accelerating at 5 m/s². If these values are within the range for their respective parameters then the parameter value will be selected.

At optional S140 it is checked whether the combination of the selected values for each parameter creates a contradiction. For example, a vehicle operating at its top speed, i.e., at the maximum end of its allowable speed range, cannot also continue to accelerate at the same time. For example, if the maximum speed of the vehicle is 100 mph at t0 and it continues to accelerate within the time range of operation after starting at 65 mph so that in a given time frame would reach 120 mph, then the result is a contradiction. Other such but even more complex cases that lead to contradiction are possible and are detected at S140. When a contradiction is determined to result, i.e., when the test result in S140 is YES, control continues with S190. Otherwise, i.e., when the test result is NO indicating that there is no contradiction, execution continues with S150.

At S150 one or more test scenarios are generated based on the values of the selected parameters. The selected parameter value ranges are added as constraints to the high-level scenario description. The now augmented scenario is compiled, and a test generation process creates various concrete tests, where each concrete test has concrete value assignments for all of the concrete test parameters. The concrete value assignments are made such that they are guaranteed to satisfy the constraints imposed by the scenario definition.

At S160 each of the one or more test scenarios are simulated. That is a simulation is run using the values of the test parameters and a pass or fail indication is generated for each scenario. The generated pass or fail indications are used within the process described herein. This is performed because a high-level scenario, having various constraints, may have internal contradictions. For example, a vehicle speed may be constrained to be between 60 and 70 mph. However, the selected road may have a speed limit of 50 mph. Such contradictions will cause the generation process to provide a fail indication. As another example, a constraint may be a one-way street where travel in the wrong direction is attempted. When the generation process fails it will provide an error indication. In other words, these failures are due to the test being wrong, e.g., for being physically impossible, which is determinable before the simulation. In addition, the pass or fail indication of each test scenario is used by the process 200 described in FIG. 2.

Generated concrete scenarios, i.e., those scenarios with concrete values assigned to all parameters, may fail during simulation if the scenario execution violates one or more specified scenario checks. For example, a check for the validity of an acceleration will be failed by the simulator if it calls for an acceleration that is not physically possible. A concrete scenario may also be failed because the execution does not follow the scenario definition. For example, a vehicle performing an overtake but whose specified speed was set to be too slow to complete the overtake by the end of the simulation, will cause the scenario to be failed. This kind of failure is different than a failure of the vehicle to perform per expectations, as such a failure of the vehicle is determined during the simulation.

Thus, there are two types of failures described above. One is a failure of the scenario, because the scenario itself has problems, and such failures may be a) static and such static failures can be found before the simulation, or b) dynamic, and such dynamic failures may be found during the simulation. These failures relate to the scenario itself and have nothing to do with the proper performance of the vehicle that is, or would be, tested by the scenario. These failures are in contrast to an improper response of the vehicle such as where, for example, the vehicle accelerates where deceleration should have happened, or where the vehicle turned left instead of turning right, and so on.

At S170 a pass/fail predictor model is updated based on the pass/fail result of each of the one or more test scenario simulations. The pass/fail predictor model is used for the purpose of prediction of whether or not a scenario will pass or fail. In order to improve the pass/fail predictor model it is updated based on the results of the simulations performed by the process 100. The pass/fail predictor model is used by the process 200 described hereinbelow in connection with FIG. 2.

At S180 the statistical distribution of the value ranges of scenario parameters is modified, and based thereon new parameter values are tested for their likelihood to achieve a pass result when simulated, which may then be used for generating future tests.

At S190 it is checked whether the process should continue, and if so, execution continues with S130; otherwise, execution terminates. In an embodiment, the check may be based on the continuation of execution of the process described in flowchart 200. That is, for as long as process 200 continues to execute then so does process 100. Doing so allows for continued updating of the pass/fail predictor model. In another embodiment, the check of S190 determines whether based on values there are additional tests that need to be generated by selection of parameters which were not previously selected before, i.e., during the selection of S130, thus requiring the performance of process 100 at least one more time.

FIG. 2 is an example flowchart 200 for narrowing of the value range for one or more parameters according to an embodiment. As noted, the process described by flowchart 200 may interact with or be executed in parallel to the process of FIG. 1 as described hereinabove.

At S210 pass/fail results of test scenarios are received. They may be received, for example from the process of FIG. 1 as described hereinabove. Those test scenarios are successful simulations that are provided along with their associated key performance indicators (KPIs).

At S220 the mapping of parameter range and KPI values of the pass/fail predictor model used by the KPI predictor is updated.

At S230 a narrower range of values is determined for each of the parameters. Specifically, determining value ranges which are most likely to get the KPIs to desired values, e.g., desired KPI values provided as inputs, for example at S210. KPIs are discussed in greater detail herein as well as illustrative desired values.

At S240 the updated parameter ranges are output for use by the process described by flowchart 100, for example at S110. In an embodiment, the narrower parameter values and predicted KPIs are stored in a database.

In S250 it is checked whether the process should continue and if so, execution continues with S210; otherwise, execution terminates. In an embodiment, the check may be of the continued execution of the process shown in FIG. 1 and described hereinabove. Note that the processes of FIG. 1 and FIG. 2 work independently from each other. They may be operating in parallel with each other and hence one may be still executing while the other has reached this point. Also, it should be appreciated that, as described herein, the process of FIG. 1 may complete for other reasons than any dependency on the process of FIG. 2.

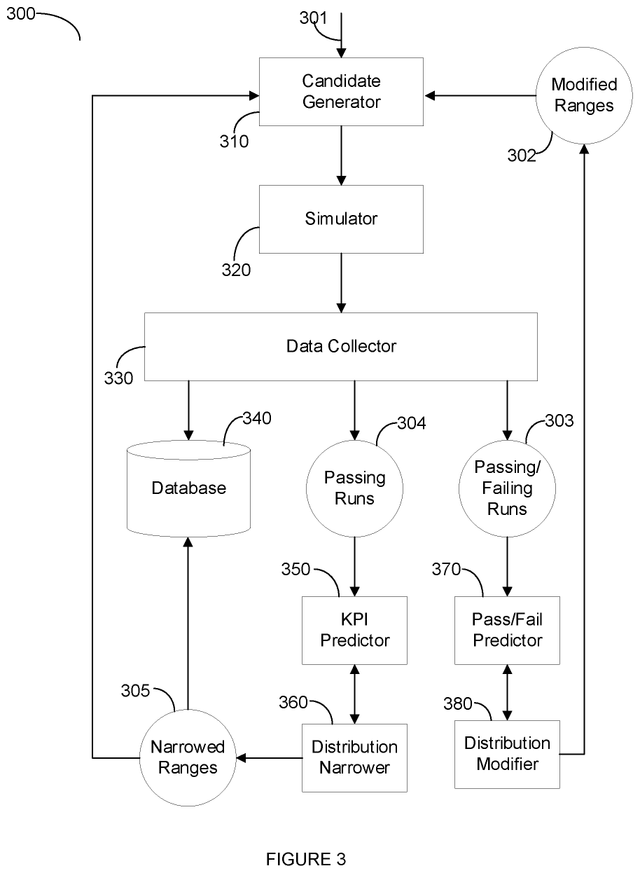

FIG. 3 is an illustrative block diagram 300 representing in part operations and in part structures for optimization of vehicular simulations according to an embodiment. The processes of FIG. 1 and FIG. 2 are, as noted, a first loop and a second loop that may be executed, in an embodiment, concurrently, and further in the context of FIG. 3.

In an embodiment the first loop, i.e., corresponding to the process of FIG. 1, may comprise: 1) receiving 301 a template file that contains the parameter ranges and one or more parameter test files. In an embodiment, a template file is a file that includes therein a way to externally parametrize a scenario written in a high-level scenario description language. The template file may be supplied by a user. The template file allows setting parameter values by the user. Each parameter has the following properties: name, type, unit, default-range, and distribution within the range.

The first loop further comprises: 2) candidate generator 310 which selects parameter values based on ranges specified for the parameters and creating test scenarios, where all parameters have values. In some cases, constraints over parameters may cause failure when a contradiction is detected; 3) a simulator 320 runs each test scenario; 4) simulation results are passed to a data collector 330 with pass/fail indications, these outputs are provided for use by 5 and 8 described herein. The outputs of passing tests, i.e., passing runs, are saved in a database 340 that associates parameter values with obtained KPIs; 5) the results 303 of runs, whether passing or failing, are passed to a pass/fail predictor 370 which updates its pass/fail predictor model, i.e., the mapping between parameter ranges and pass/fail results; 6) a distribution modifier 380 changes the parameter value ranges, testing the new value ranges with the pass/fail predictor 370 to produce new parameter value ranges 302 which are likely to result in passing a test; 7) as may be necessary, return to step 2) for another iteration.

In an embodiment, the second loop, i.e., corresponding to the process of FIG. 2, may comprise of the steps: 8) passing runs 304 with their KPI results are provided to the KPI predictor 350 which changes mapping between parameters ranges and KPI values in the internal model of the KPI predictor 350; a distribution narrower 360 selects narrower ranges for at least some of the parameters, doing so via interaction with the KPI predictor 350 to select parameter value ranges that are more likely to drive KPIs to desired values, than those, for example, provided by the inputs 301. The narrowed value ranges and predicted KPI values are saved in the database 340; 10) the narrowed ranges 305 are passed to the candidate generator 310, thereby going back to step 2) of the first loop.

In an embodiment, the termination condition for the operation of optimization of vehicular simulations may be based on reaching or exceeding certain criteria, such as, for example, time elapsed, a resource exhaustion limit, a distance of the KPI from the desire KPI value, the like and any permissible combinations thereof.

According to an embodiment there are two predictive branches for the optimization of vehicular simulations according to an embodiment. The KPI predictor 350 branch that is adapted to predict (map) an input to any real number in (−inf, inf). The pass/fail predictor 370 branch predicts (classifies) an input to Pass or Fail. The KPI predictor 350 is used in conjunction with the distribution narrower which is exploitation oriented. The pass/fail predictor 370 is used in conjunction with the distribution modifier 380, which deals with the exploration-exploitation dilemma, i.e., a trade-off between exploration, which aims to maximize short-term rewards, and exploitation, which disregards short-term rewards to the expense of gaining knowledge that might gain/lead to long term rewards.

In an embodiment, in order to implement a predictor, for example the KPI predictor 350 or the pass/fail predictor 370, a surrogate function may be used. The surrogate function is a technique used to best approximate the mapping of input examples to an output score. Probabilistically, it summarizes the conditional probability of an objective function (f), given the available data (D) or P(f|D). Several techniques can be used for this, although the most popular is to treat the problem as a regression predictive modeling problem with the data representing the input and the score representing the output to the model. This is often best modeled using a random forest or a Gaussian Process (GP).

Advantageously, use of the arrangements of the instant disclosure provide for objective criteria being applied to the selection, simulation and prediction, leading to results which are consistent, something that cannot be achieved should different humans attempt to perform simulation or even when a single human attempts to perform these tasks repeatedly. In practice, the number of possible permutations for KPIs, parameter range adjustments, and parameter values selection will be quite large and beyond the ability of a human to practically perform.

Some of the KPIs employed may relate to safety measures. These include, for example: number of crashes, where crashes may be further distinguished by crashes that cause only property damage and crashes that result in injuries and fatalities, in total and per 100 million km or miles; number of instances where the driver must take manual control from the automated driver per 1000 km or miles; number of conflicts encountered where time-to-collision (TTC) is less than a pre-determined threshold per 100 million km or miles; number of instances with hard braking, i.e., high deceleration, per 1000 km or miles; number of false corrective actions taken, i.e. instances where the vehicle takes unnecessary collision avoidance action, per 1000 km or miles; number of instances rated by a human as being of increased risk or not correctly handled by the automated vehicle per 1000 km or miles; and, proportion of time when time-to-collision (TTC) is less than a pre-determined threshold.

Some of the KPIs employed may relate to vehicle operations measures include, for example: number of instances where the driver must take manual control from the automated driver per 1000 km or miles; mean and maximum duration of the transfer of control between a human driver and the automated driver vehicle, e.g., when requested by the automated driver of the vehicle; number of emergency decelerations per 1000 km or miles; and mean and maximum longitudinal acceleration and deceleration. Desired values of such KPI may be a maximum value, a minimum value, a range of acceptable values, and the like.

A GP, that may be used for the pass/fail predictor 370, is a model that constructs a joint probability distribution over variables, assuming a multivariate Gaussian distribution. As such, it is capable of efficient and effective summarization of many functions and may provide for a smooth transition therebetween as more observations are made available to the model. This smooth transition from one function to another are desirable as the domain, e.g., parameters of a scenario, is sampled, and the multivariate Gaussian basis to the GP model indicates that an estimate from the model is a mean of a distribution having a standard deviation. Hence, the use of a GP regression model is often a preferred model of choice.

An important aspect in defining the GP model is the kernel. This controls the function shapes at specific points based on distance measures between actual data observations. Many different kernel functions can be used, and some may offer better performance for specific datasets. Commonly, a Radial Basis Function (RBF) is used. The model estimates the cost for one or more samples provided to it. The result for a given sample is a mean of the distribution at that point. Surrogate functions may be called at any time to estimate the cost of one or more data samples, such as when optimization of the distribution modifier 380 or the distribution narrower 360 is necessary.

In an embodiment, in order to implement changes in distribution, for example by the distribution modifier 380 or the distribution narrower 360, an acquisition function may be used. As noted, the surrogate function is used to test a range of candidate samples in the domain. From these results, one or more candidates, e.g., of the parameter values, can be selected and evaluated with the real, and in normal practice, computationally expensive cost function. This involves two parts: a) the search strategy which is used to direct the domain in response to the surrogate function; and, b) the acquisition function that is used to interpret and score the response from the surrogate function.

A simple search strategy, such as a random sample or grid-based sample, can be used, although it is more common for a GP to use a local search strategy, such as the popular Broyden-Fletcher-Goldfarb-Shanno (BFGS) algorithm. First, drawing a random sample of candidate samples from the domain, evaluating them with the acquisition function, then maximizing the acquisition function or choosing the candidate sample that gives the best score. The acquisition function is responsible for scoring or estimating the likelihood that a given candidate sample, e.g., an input, is worth evaluating with the real objective function.

In an embodiment a surrogate score may be used directly. In another embodiment, given that a Gaussian Process model as the surrogate function exists, probabilistic information from this model in the acquisition function may be used to calculate the probability that a given sample is worth evaluating.

There are many different types of probabilistic acquisition functions that can be used, each providing a different trade-off for how exploitative, e.g., greedy, and explorative they are. Three common examples are: Probability of Improvement (PI), Expected Improvement (EI), and, Lower Confidence Bound (LCB). The Probability of Improvement method is the simplest, whereas the Expected Improvement method is the most commonly used.

For example, the simpler Probability of Improvement method, which is calculated as the normal cumulative probability of the normalized expected improvement, calculated as follows: PI=cdf((mu−best_mu)/stdev), where PI is the probability of improvement, cdf( ) is the normal cumulative distribution function, mu is the mean of the surrogate function for a given sample x, stdev is the standard deviation of the surrogate function for a given sample x, and best_mu is the mean of the surrogate function for the best sample found so far. In an embodiment a very small number may be added to the standard deviation to avoid a divide by zero error.

In an embodiment, a Bayesian Optimization algorithm may be used to optimize the selection of parameter value ranges. The main algorithm of the Bayesian Optimization involves cycles of selecting candidate samples, evaluating them with the objective function, then updating the GP model.

FIG. 4 is an illustrative block diagram of a system 400 having a memory with instructions that cause processing circuitry to perform optimization of vehicular simulations according to the principles of the disclosure. A processing circuitry 410 is communicatively connected to a memory 420. The processing circuitry 410 may be realized as one or more hardware logic components and circuits. For example, and without limitation, illustrative types of hardware logic components that can be used include field-programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, whether general purpose or specialized processors, or any other hardware logic components that can perform calculations or other manipulations of information. The processing circuitry 410 is configured to perform optimization of vehicular simulations as described herein when executing code stored in memory 420.

The memory 420, which is communicatively connected to the processing circuitry 410 via connection 450, may be volatile, e.g., random access memory (RAM) etc., non-volatile, e.g., read only memory (ROM) flash memory, etc., or a combination thereof. In one configuration, computer-readable instructions, also referred to as software or code, to implement one or more embodiments disclosed herein may be stored in memory code 425 of memory 420. In another embodiment some or all of the computer-readable instructions to implement one or more embodiments disclosed herein may be stored in storage 440.

Software shall be construed broadly to mean any type of instructions, whether referred to as software, firmware, middleware, microcode, hardware description language, or otherwise. Instructions may include code, e.g., in source code format, binary code format, executable code format, or any other suitable format of code. The instructions, when executed by the processing circuitry 410, cause the processing circuitry 410 to perform the various processes described herein.

The connection 450 may employ any form of inter-circuitry communication, such as, a bus, which may be parallel or serial, a network, which may be wired or wireless, and any combinations thereof. The connection 450 further communicatively couples input/output (I/O) interface (IF) 430 to at least the processing circuitry 410. The connection 450 may also communicatively couple storage/database 440 to processing circuitry 410, memory 420, I/O IF 430. I/O IF 430 may also be communicatively coupled to memory 420 by the connection 450.

The I/O IF 430 may provide one or more types of input and/or output communication to the system 400. For example, the I/O IF 430 may provide connectivity to one or more peripheral to the system 400, the likes of a keyboard, a mouse, a display, a touchpad, a touchscreen, serial I/O, and the like. The I/O IF 430 may further provide network communication such as local area network (LAN), wide area network (WAN), metro area network (MAN), the worldwide web (WWW), the Internet, and other like wired communication, as well as Bluetooth®, WiFi®, cellular, and other like wireless networks, and any combinations thereof.

The storage/database 440 may be magnetic storage, optical storage, and the like, and may be realized, for example, as flash memory, for example in the case of solid-state disk (SSD) or other memory technology, compact disk-read only memory (CD-ROM), Digital Versatile Disks (DVDs), or any other medium which can be used to store information. In an embodiment a database, for example database 340, may reside therein.

The various embodiments disclosed herein can be implemented as hardware, firmware, firmware executing on hardware, software, software executing on hardware, or any combination thereof. Moreover, the software is implemented tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (CPUs), a memory, and input/output interfaces. The computer platform may also include an operating system and microinstruction code. The various processes and functions described herein may be implemented as either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for providing a test scenario for simulation of an interaction of a plurality of vehicles by a computer system, the method comprising:
receiving a scenario involving at least the plurality of vehicles, wherein the scenario is described in a high-level scenario description language;
receiving a plurality of parameter values for the received scenario;
modifying the plurality of parameter values according to at least one of a pass/fail predictor model and a pass/fail indication;
narrowing a range of values of at least one parameter of the plurality of parameters by prediction of at least a key performance indicator (KPI) value using a KPI predictor; and
generating a test scenario for the simulation of the interaction of the plurality of vehicles within the received scenario based on at least the narrowed range of values.

2. The method of claim 1, wherein modifying by the pass/fail predictor model further comprises:
receiving past results corresponding to use of past parameter values used in past simulation of the scenario;
receiving pass/fail indications corresponding to the past results;
modifying a distribution modifier with respect to the received past parameter values and the received resultant pass/fail indications; and
changing parameter value probabilities to improve pass rates for the received scenario using the modified distribution modifier.

3. The method of claim 2, wherein modifying a distribution modifier is based on at least one of: a random sample, a grid-based sample, and a local search.

4. The method of claim 3, wherein the local search is performed using a Broyden-Fletcher-Goldfarb-Shanno (BFGS) algorithm.

5. The method of claim 1, narrowing a range of values of the plurality of parameters further comprises:
receiving, by a KPI predictor, past parameter values;
receiving, by the KPI predictor, past KPI results; and
tuning at least one of the plurality of parameters to a narrower range, wherein the narrower range increases a probability of improving at least one KPI.

6. The method of claim 1, wherein a vehicle of the plurality of vehicles is one of: a car, a truck, a motorcycle, a locomotive, a bicycle, a scooter, and a drone.

7. The method of claim 1, wherein the prediction of at least a key performance indicator (KPI) value is performed by a surrogate function.

8. The method of claim 7, wherein the surrogate function is regression predictive modeling.

9. The method of claim 8, wherein the regression predictive modeling employs at least one of: a random forest and a Gaussian process.

10. A non-transitory computer readable medium having stored thereon instructions for causing a processing circuitry to execute the process of claim 1, wherein the process performs, when executed by a digital computer a test scenario simulation of an interaction of a plurality of vehicles.

11. A system for generation of a test scenario for simulation of an interaction of a plurality of vehicles, the system comprising:
a processing circuitry;
an input/output (IO) interface, communicatively connected to the processing circuitry and configured to provide communication to and from the system;
a memory communicatively connected to the processing circuitry, a portion of the memory containing there in instructions that when executed by the processing circuitry configure the system to:
receive a scenario involving at least the plurality of vehicles, wherein the scenario is described in a high-level scenario description language;
receive a plurality of parameter values for the received scenario;
modify the plurality of parameter values according to at least one of a pass/fail predictor model and a pass/fail indication;
narrow a range of values of at least one parameter of the plurality of parameters by prediction of at least a key performance indicator (KPI) value using a KPI predictor; and
generate a test scenario for the simulation of the interaction of the plurality of vehicles within the received scenario based on at least the narrowed range of values.

12. The system of claim 11, wherein for modifying by a pass/fail prediction the memory contains therein instructions that when executed by the processing circuitry further configure the system to:
receive past results corresponding to use of past parameter values used in past simulation of the scenario;
receive pass/fail indications corresponding to the past results;
modify a distribution modifier with respect to the received past parameter values and the received resultant pass/fail indications; and
change parameter value probabilities to improve pass rates for the received scenario using the modified distribution modifier.

13. The system of claim 12, modifying a distribution modifier is based on at least one of: a random sample, a grid-based sample, and a local search.

14. The system of claim 13, wherein the local search is performed using a Broyden-Fletcher-Goldfarb-Shanno (BFGS) algorithm.

15. The system of claim 11, wherein for narrowing a range of values of the plurality of parameters the memory contains therein instructions that when executed by the processing circuitry further configure the system to:
receive, by a KPI predictor, past parameter values;
receive, by the KPI predictor, past KPI results; and
tune at least one of the plurality of parameters to a narrower range, wherein the narrower range increases a probability of improving at least one KPI.

16. The system of claim 11, wherein a vehicle of the plurality of vehicles is one of: a car, a truck, a motorcycle, a locomotive, a bicycle, a scooter, and a drone.

17. The system of claim 11, wherein the prediction of at least a key performance indicator (KPI) value is performed by a surrogate function.

18. The system of claim 17, wherein the surrogate function is a regression predictive modeling.

19. The system of claim 18, wherein the regression predictive modeling employs at least one of: a random forest and a Gaussian process.
